(19) United States
(12) Patent Application Publication
(10) Pub. No.: US 2016/0048861 A1
(43) Pub. Date: Feb. 18, 2016

(54) METHOD AND SYSTEM FOR DYNAMICALLY CREATING AND TRANSFERRING DATA CORRESPONDING TO A BENEFIT FROM A WEB PAGE TO A MOBILE APPLICATION BY USING A WEB-BASED MARKER

(71) Applicant: NETMENO, Paris (FR)

(72) Inventor: Sylvain Morgaine, Paris (FR)

(21) Appl. No.: 14/781,668

(22) PCT Filed: Apr. 1, 2014
(86) PCT No.: PCT/IB2014/000469

§ 371 Date: Oct. 1, 2015

Related U.S. Application Data
(60) Provisional application No. 61/807,086, filed on Apr. 1, 2013.

(51) Int. Cl. G06Q 30/02

(52) U.S. Cl. CPC G06Q 30/0214; G06Q 30/0226; G06Q 30/0239; G06Q 30/0233

(57) ABSTRACT

It concerns a method and system for dynamically creating a benefit using a web-based marker displayed inside an internet browser to transfer the benefit to a mobile phone application. It comprises (i) creating a web-based marker using a dedicated user-interface or an API, (ii) creating an HTML content for said benefit using said user-interface, (iii) associating said HTML content to said web-based marker, (iv) installing a dedicated Javascript library on a website to manage the display and functionality of said web-marker, (v) creating the HTML tags necessary to display said marker, (vi) activating said marker, (vii) checking whether the user's mobile application was previously paired with the internet browser displaying said web page by checking an HTTP cookie, or (viii) pairing the mobile application (ix) polling local data provided by the mobile application, (x) adding said marker to the user's web context, upon activation of said marker, (xi) sending a content list corresponding to said benefit based on user profile, mobile and web context, (xii) displaying said content list inside the mobile application once and as soon as the application is connected to the internet, and (xiii) storing said benefit in the mobile's phone application local memory.

### FIELD

Embodiments of the present invention relate to the tagging of web content displayed within a web page in order to transfer data associated to a benefit dynamically and anonymously to a mobile device. Specifically, embodiments of the invention allow an internet content provider or e-retailer to send data such as loyalty points, bookings, promotions, flash sales, discounted tickets, gift cards or the like to a user's mobile phone in real-time, by placing a marker button either visible or hidden on said web content.

By data associated to a benefit, one should understand a structured content comprising the display of visual information such as text, images, video describing a product information, offer, quiz, vote, etc. and a functional part allowing the user to act upon said benefit, for example by redeeming a coupon, buying a product, setting reminders, voting, etc.

### BACKGROUND

Brick and mortar retailers can use E-commerce as an additional channel to sell their products. Nevertheless, most retailers have a web site but do not sell online because of the required logistics necessary to process, manage and deliver orders for a small line of products or the need for some products to be generally tried-out or tried-on by the consumer before purchasing.

Furthermore, today's consumers are always connected thanks to their mobile phone allowing them to compare prices, try out products in one physical store and buy online in a competing store at a cheaper price. This emerging behaviour contributes to a potentially growing loss in revenues for stores that do not offer the possibility to offer in-store competitive prices.

Moreover, retailers with no E-commerce site need to find a way to drive traffic to their stores and generate additional sales.

To reach this objective, retailers generally inform consumers through traditional marketing channels such as television, radio, outdoor posters, flyers, mailed catalogs, etc. with links to their website for online purchases or additional product information.

While these marketing channels have proved to be successful in the past, current advertising overload and lack of personalisation makes it difficult for consumers to aggregate and save information and offers via said marketing channels. Even current e-mailing and SMS campaigns are becoming more and more intrusive as their number increases whether solicited or not. Thereby the technical process of securing the success of a retailer's call-to-action is becoming more and more complex.

Methods for transferring web content to mobile phones are already known such as U.S. Pat. No. 7,716,281 which details a method and system for embedding a web browser into a web page in order to drag and drop content from that web page into said web browser in order to make the content available to a mobile phone via a URL link.

Publication WO/2012/139003 of PCT/US2012/032529 describes a method for facilitating the passing and redeeming of coupons via a web page accessed from a mobile phone.

The above methods use a URL (Uniform Resource Locator) link from a server to the user's mobile phone forcing the user to access a web page from said mobile phone for each and every transfer of new data. Moreover, to view said transferred data, a link needs to be transmitted to the user via a distribution channel such as an SMS, email, matrix barcode (for instance QR code), NFC, micro-blogging service message (such as tweet) or the like to the mobile's web browser requiring the placement of the link for any of the above distribution channel. Furthermore, these methods do not provide any way for the user to save and store on the mobile phone, multiple content acquired within the same web page, across pages or across multiple web sites. Finally, the first patent's method requires the user to input a cellular phone number in order to receive the content link(s) via SMS forcing the user to reveal his phone number for the method to work which can be intrusive.

The second patent also requires an intermediate channel to transmit the link resulting in additional steps on behalf of the user in order to obtain the coupons.

### SUMMARY

This Summary is provided to introduce a selection of concepts that are further described below in the Detailed Description.

This Summary is not limitated or to identify limitatively key features or essential features of the invention.

Embodiments of the present invention provide a method and a system for dynamically creating a function to be used by a user or data information to be further processed, said function or data information being called hereafter a benefit, said method using a web-based marker prealably created and displayed inside an internet browser or a web application and transferring said benefit to user's mobile phone application.

In an advantageous embodiment, the benefit is transferred to the user anonymously, that is without any personal data collected such as login information, email, mobile phone number and the like.

Advantageously the steps involved are as follows:

(i) creating a web-based marker using a dedicated user-interface or an API (Application Program Interface).
(ii) creating an HTML content for said benefit using said user-interface
(iii) associating said HTML content to said web-based marker
(iv) installing a dedicated Javascript library on a website to manage the display and functionality of said web-marker
(v) creating the HTML tags necessary to display said marker
(vi) activating said marker
(vii) checking whether the user's mobile application was previously paired with the internet browser displaying said web page by checking an HTTP cookie,
(viii) Otherwise pairing the mobile application using a challenge/response synchronization mechanism known by the skilled practitioner (for example further described in reference to FIG. 3).
(ix) Getting or polling local data provided by the mobile application such as for example the user's anonymous profile and/or elements to provide access to mobile context information such as GPS coordinates.
(x) Adding said marker to the user's web context, by sending said functional parameters to a server upon activation of said marker.
(xi) Send a content list corresponding to said benefit based on user profile, mobile and web context.
(xii) Displaying said content list inside the mobile application once and as soon as the application is connected to the internet, and
(xiii) Storing said benefit in the mobile's phone application local memory.

The invention also proposes a system comprising means to implement any of the above mentioned steps.

One of the objectives of at least some embodiments is to solve the problem of obtaining and managing user benefits, when said benefits are offered via a web site but requires to be used in a different context. For example, tickets for shows or sporting events can be booked online but require to be shown at the gate; a 20% discount for a clothing item that needs to be tried-on before purchasing; a $100 off coupon for a new TV model that needs to be compared with other models at the store; a free test-drive at a nearby car dealer, loyalty points automatically incremented every time a user visits a specific web page and redeemed, for example, at a nearby store, etc. All of the above examples could be implemented by printing the ticket or the offer, requesting the user's mobile phone and sending a text message or by directly sending the user an email. Nevertheless, these procedures require the user to manage different pieces of paper or digital messages which, over time, would be difficult to remember and find. Furthermore, as the user acquires multiple benefits from multiple web sites, the process of saving and searching for these benefits could also turn out to be unmanageable.

Moreover, the invention specifically addresses the creation and use of a functional benefit such as unlocking specific functionalities inside a physical toy or game requiring said toy or game firmware (software) to be updated via a bluetooth connection.

As a result, the objective is achieved by generating one or more web-based markers on a web page and automatically transferring and storing to the user's mobile application the benefits associated with said markers upon activation of the marker by the user as disclosed by the present invention. Accordingly, the owner of a website, referenced hereafter as the operator, hosting said web page creates a marker using a web administration tool hosted on a server. This process comprises one or more of the following steps of:
Specifying one or more website(s) where the markers need to be installed,
Validating said website(s) using a verifying mechanism known by the skilled practitioner. This is implemented by inserting the following example code line:

<meta name=“site-verification”content=
“8m8hywv2t90britg67iwadpj8p9owjoy3”>,

Selecting the type of marker to be created among the main following types: Button, Page, Video, Sound;
Selecting a content template and entering the content parameters defining the benefit associated with the marker, such as product title, description, price, discount and the functional parameters such as time notification, geolocation notification purchase URL, bluetooth code, etc;
Selecting the options required for the user to activate or redeem said benefit, such as using an NFC reader, bar code scanning, in-store bluetooth beacons, biometric scan, bluetooth code upload, or the like;
Generating the marker's code corresponding to the type of marker; for instance the code is using HTML;
Storing the marker's UUID (Universally Unique IDentifier), the website domain name and the marker's content parameters to a relational database on said server.
Enabling the use of said marker on the web page by associating said content with said marker.

Advantageously, the invention proposes a method and a system wherein the steps and/or the means are arranged to award incremental points in a specific register of the mobile device when the user clicks on a button on a web page, and/or when the user plays video or sound content on a web page, and/or when the user loads a web page on a section of a web page, and/or wherein the use of a benefit is customized according to local data provided by the mobile phone such as GPS coordinates.

Advantageously, the benefit parameters contains the nearest point from the user's location to redeem benefit, and/or said local data is provided by a local wireless device such as a wifi router, Bluetooth beacon, NFC tag or the like.

In an advantageous embodiment, the mobile contains an accelerometer (known per se) and said local data contains accelerometer information, and/or a microphone and/or image camera data of the mobile arranged to complete such local data.

Once the marker has been generated it can be used by installing the marker's code (Javascript and HTML) on the web page comprising steps known to the skilled practitioner and briefly described below:

A link to a (Javascript) library for using the marker's code is then added to the web page. For instance, the following HTML command tells the page to load the library “markers.js” performing the following main operations for a button marker:

<script src=“//miwo.io/lib/markers.js”></script>

The code is also provided to create or place an HTTP cookie in the user's web browser indicating weather or not pairing is effective.

The following HTML code is inserted in the web page in order to transmit the button's UUID to the server once the user activates the marker by clicking on said button:

<div class=“miwo-marker” data-uuid=“40421104-9ca7-4669-ad01-
206f69d09400”></div>

Video and sound can also be tagged with markers at any specified time during playback.

Following are two basic HTML example code for creating a video and sound marker:

```
<video src=“video_example.webm” class=“miwo-marker”
uuid=“d8860095-2534-4cf2-b9b7-21845a174761” controls></video>
<audio class=“miwo-marker” uuid=“cf01a4a4-668d-40bf-9637-
83f1330cb34c” controls>
  <source src=“audio_example.ogg” type=“audio/ogg”>
  <source src=“audio_example.mp3” type=“audio/mpeg”>
</audio>
```

It is noted that the trigger parameters for activating the video or sound markers are implemented in the “markers.js” Javascript library.

In one embodiment, the generated marker's code defines a simple button on a web page. When the button is clicked, a request is sent to the server in order to verify the marker's UUID and domain name against the ones stored in the database during the marker creation process described above.

This operation prevents a fraudulent use of the button installed on a different domain name or URL. If the UUID and domain name have been validated, the Javascript code checks if the mobile application has already been paired with the user's browser, in other words, if said cookie was created. If the cookie was created then the benefit is transferred to the user's mobile application by writing said parameters to the user's database entry; otherwise the user is asked to pair the mobile application with the browser.

In another embodiment, the generated marker's code defines different benefits to be triggered at different times during the playback of a video sequence. For example, a vote triggered at a specific time during playback asking the user to answer some questions in exchange for some instant benefit (loyalty points, discounts, gift card, etc.). The time trigger indicates when to activate the marker and alert the user's mobile phone of the possibility to receive the benefit as well as when to display the associated graphical cue on the video to inform the user of the presence of said benefit inside the video sequence.

In the case of a marker embedded within or associated with a video content, the marker is activated when the time trigger is reached while playing the video. As soon as the time trigger is reached, a request is sent to the server to enable the notification of the user's mobile application. The mobile application connected to the server is then instantly notified and the user is asked to accept or deny the reception of said benefit on his mobile phone. If accepted, the benefit's content is added to the user's mobile application and said parameters corresponding to the user's database entry are registered in the same way as described above for the button marker.

Likewise the same marker behaviour applies when embedding or associating a marker with a sound content.

In a further embodiment, the generated marker's code is activated as soon as the user loads a web page or a section of a web page. When the marker is activated, a request is made to the server to increment, for example, a number of points used to increase the user's loyalty to the web site. The marker activation automatically adds said loyalty points to the mobile application.

In yet another embodiment, the generated marker code is associated with a plurality of airline services made available through an aircraft's In Flight Entertainment (IFE). According to the invention, the passenger establishes a temporary pairing between the IFE and his mobile phone, which allows the phone to interact with said services during the length of the flight. For example, the passenger can choose to rent a car, make a restaurant reservation, book theatre tickets, bookmark shopping opportunities, etc. These services can be discounted to offer an additional benefit to the passenger. Once the reservation is validated, said benefit is added to the user's mobile application in the same way described above for the button. If the passenger rented a car, he would show the reservation entry on his mobile phone at the rent-a-car counter upon arrival at the airport.

As can be appreciated from the above and from additional description herein, embodiments of the present invention solve various problems through a method for attaching one or more web-based markers to one or more content sections of a web page displayed by an internet browser. The marker can be visible on the web page such as a button or an internet link or invisible when embedded within a web page, video or sound content.

The marker may be used to dynamically generate and transfer a commercial benefit such as incrementing loyalty points, delivering promotions, flash sales, bookings, discounted tickets, gift cards or the like, from said web page to a dedicated mobile application which then allows the transmission of such benefit to a cash register, a printer or another mobile device via electromagnetic waves using for instance Wifi, Bluetooth, Near Field Communication (NFC) or the like.

Advantageously, said benefits may be transferred from at least one server instances comprising a plurality of web-based content. Said content can be provided by a plurality of web-enabled devices such as a PC, notebook, tablet, smartphone, connected-TV, connected-objects and the like.

Once the benefit has been added to the mobile application, it can be automatically stored in a dedicated section, resulting in an easily-manageable, aggregated list of all benefits inside one and unique place. Furthermore, said benefits may be stored in the local memory of said mobile application in order to allow access when the mobile phone is not connected to the Internet.

### BRIEF DESCRIPTION OF THE DRAWINGS

The accompanying drawings illustrate non-limitatively embodiments of the present invention, and together with the description serve to explain principles of embodiments of the invention. Other features and advantages of the invention will become more clearly apparent on reading the following description of embodiments of the invention, given as an illustrative and non-limiting example, and from the appended drawings in which:

FIG. 1 shows the main components of the general architecture of a first embodiment of the system of the invention.

FIG. 1.A shows an overview of the real-time communication architecture between the main sub-components of the system of FIG. 1.

FIG. 1.B shows a flow diagram of the sensor detection plug-in according to the embodiment more particularly described in reference to FIG. 1.

FIG. 1.C shows the network sessions between the server, the web browser and the mobile client according to the embodiment of FIG. 1.

FIG. 2 shows an overview diagram of the web device marker activation according to an embodiment of the invention.

FIG. 2.A shows an overview diagram of the mobile client marker activation

FIG. 3 shows a main flow diagram of the pairing mechanism according to an embodiment of the invention.

FIG. 4 shows the process by which the user activates a button marker in another embodiment of the invention.

FIG. 5 shows the process of pairing the browser with the mobile application in an embodiment of the invention.

FIG. 6 shows an overview of the process for activating the web marker when embedded inside a video content according to a specific embodiment of the invention.

FIG. 7 shows a basic scenario for using a button marker inside a web page and receive the associated benefit inside his mobile application to be redeemed at the closest user location in an embodiment of the invention.

FIG. 8 shows an overview of the process for activating a marker inside an In Flight Entertainment System according to an embodiment of the invention.

### DETAILED DESCRIPTION OF EMBODIMENTS

As indicated above, the embodiment of the present invention more particularly described here includes a method for dynamically creating a benefit using a web-based marker integrated inside a web site and transferring said benefit to a mobile phone application. The method eliminates the need to use an intermediate channel such as a text message, QR code, email, browser plug-in or the like to obtain said benefit by pairing once, the mobile application with a user's Internet browser and automatically delivering the benefit to said mobile application.

The pairing procedure equally eliminates the need for the user to register in order to receive said benefits on his mobile application. Eliminating the registration process secures the user's anonymity and prevents any malicious or unwanted use of his email or mobile phone number.

In a preferred embodiment the method specifically allows to access local data provided by the mobile phone, such as the anonymous user profile or sensor data such as the anonymous user profile or sensor data such as the precise GPS or indoor location of the user in order to customize the delivery of said benefit, for example indicating the closest store accepting a gift card.

Advantageously, said benefits, can be gathered from a plurality of websites and automatically stored in one and unique location inside a mobile application without requiring any further steps on behalf of the user.

In one embodiment of the invention, the operator registers on a web administration platform. Once registered, the operator creates a marker using a dedicated web administration tool. The tool allows the operator to perform the main following operations:
define the type of marker to be installed on the web site among said page, button, video and sound marker types,
create the display and functional parameters of said benefit, that is, the visual and textual content of the benefit as well as the associated interaction (reminders, purchase options and other call to action),
associate the benefic content with said marker.

Once all of the information is completed and saved:
The button UUID and associated parameters are stored on the server,
The HTML code needed to be installed on the operator's web site is generated,

The last step involves the integration of the generated marker code inside said web site.

In the case of multiple markers needed to be installed on the operator's web site, such as for multiple products on an E-commerce site, an API (Application Program Interface) is provided to the operator in order to automate the creation of multiple markers. This API is used by a software plug-in compatible with the e-commerce CMS platform.

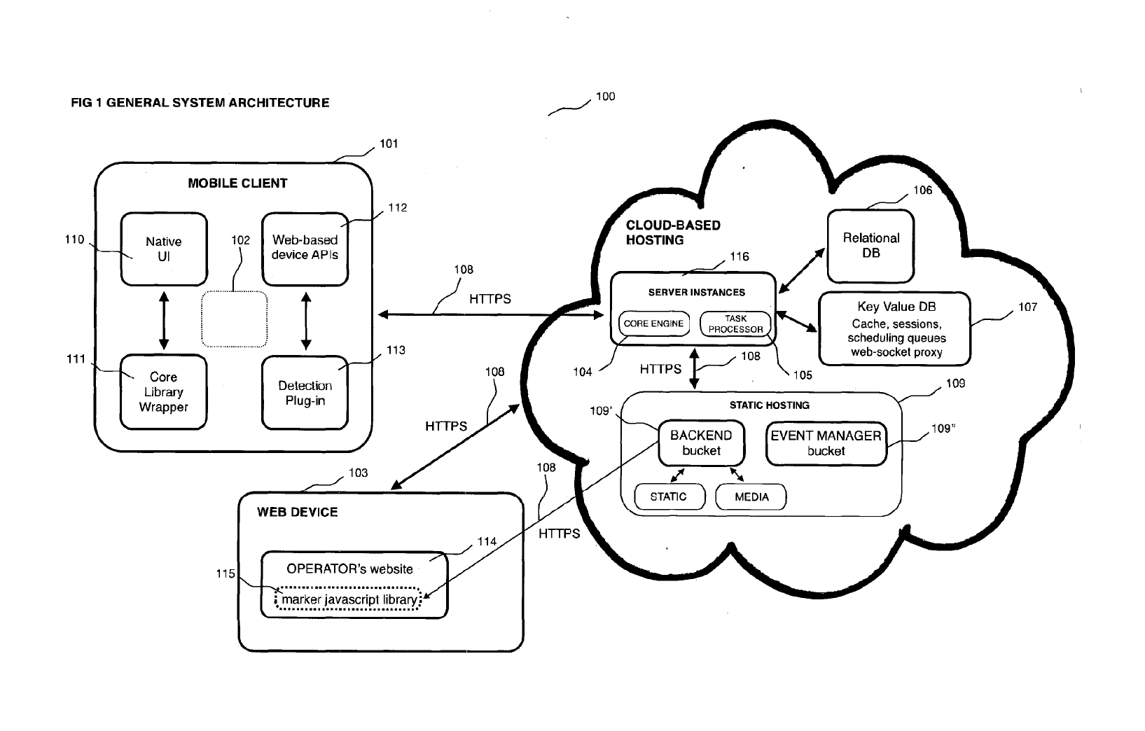

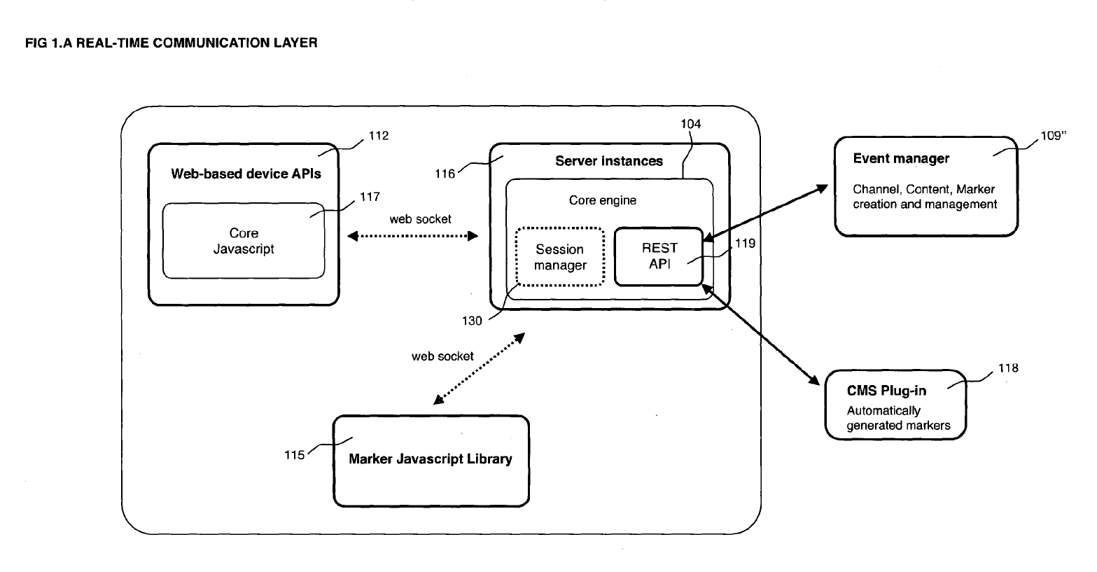

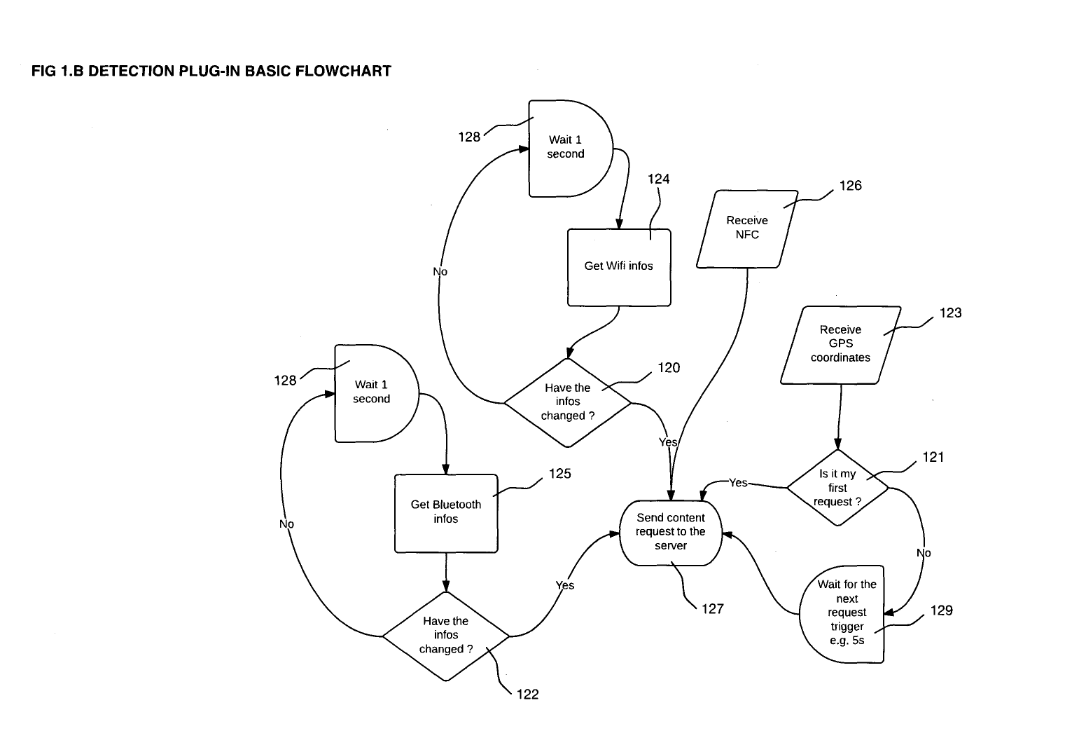

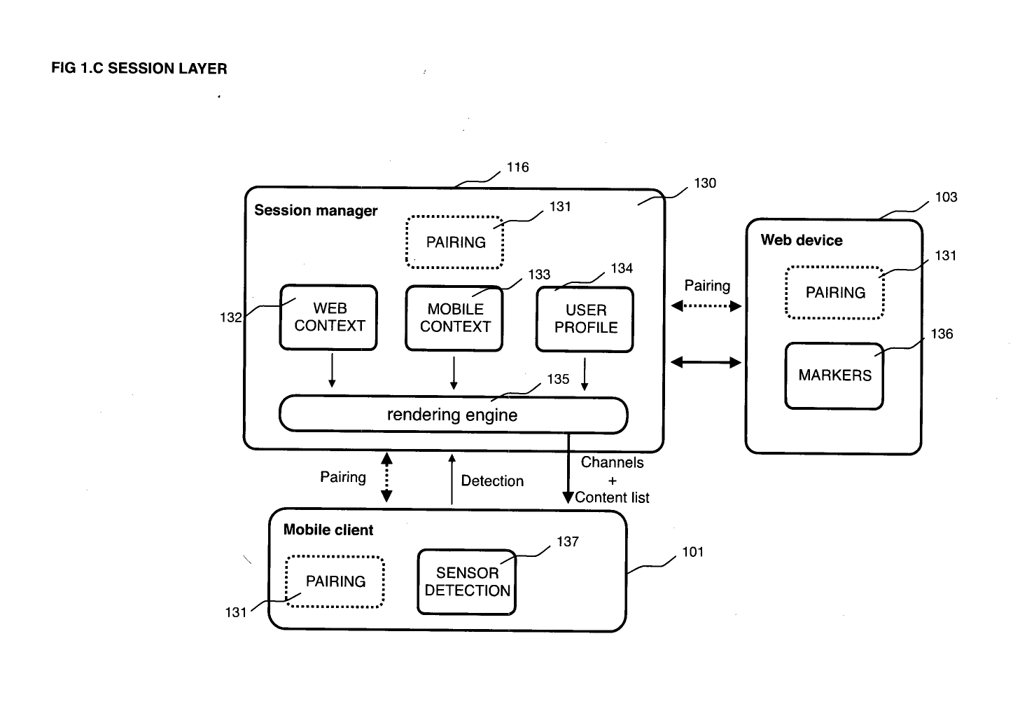

FIG. 1 shows the general system 100 architecture detailing the sub-components involved in this embodiment of the invention. The mobile application based in the mobile client 101 integrates a library wrapper 111 which allows access to all the core-javascript functions which are using the native User Interface 110 in a manner know per se. A web-based device API 112 is used as the interface between the core-javascript (accessed via wrapper 11) and the native mobile client hardware 102 such as GPS, Wifi, Bluetooth sensors. Said sensors follow a detection algorithm implemented as a Plug-in module 113 and detailed in reference to FIG. 1.B.

The web device 103 such as a PC or tablet is used to display the operator's website 114 containing the Marker Javascript library 115 required to implement the pairing process, marker management, session management and operator access to the mobile context and user profile.

The system uses cloud-based server instances 116 comprising a cone engine 104, task processors 105, all connected to relational data base 106, and key value Data Base 107.

All these elements are known to the skilled practitioner to handle all real-time communication between the mobile client and the web device. Each server request uses the HTTPS protocol (lines 108) for secured communication.

FIG. 1A details the real-time communication layer connecting both the web-based device API 112 and the Marker Javascript library 115 to the server instances 116. The Core Javascript code 117 is handling the system's main functions: Pairing process, Event management, Cache and Synchronisation, User profile management. The Event Manager 109″ (see FIG. 1) is handling the creation of markers and the associated benefit content. A CMS Plug-in 118 is used to automatically generate button markers on e-commerce sites requiring a large amount of buttons. The Plug-in uses a specific API 119 for this process as referenced in FIG. 9.

FIG. 1B details the Plug-in detection module 118 used by the system to determine the user's local environment. The module continuously checks (tests 120, 121, 122) the user's mobile sensors (for example, GPS coordinates 123, Wifi infos 124, Bluetooth beacons 125 and NFC detection 126) and returns to the servers (step 127) after waiting steps 128 (wait 1s for instance) or any of the next request trigger (5s for instance (129)) a list of markers that have been associated with the corresponding sensor data.

FIG. 1C details the session layer undertaken within the cone engine 104 of the server instances 116, and specifically the session manager 130 (also in interrupted line on FIG. 1A) responsible for handling all the user processes. There are 2 main session types: the Pairing 131 between the mobile client and the web device and the context detection modules 132, 133, 134. The web context module 132 gets the context from the web page by checking if a marker 136 has been clicked or activated on the web device 103. The mobile context module 133 gets the user's mobile environment from the detection Plug-in 113 and checks if any markers 136 have been associated with any mobile sensor 137. Finally, the rendering engine 135 gets the content associated with the different markers based on said contexts, checks the user profile 134 and builds the content list of benefits.

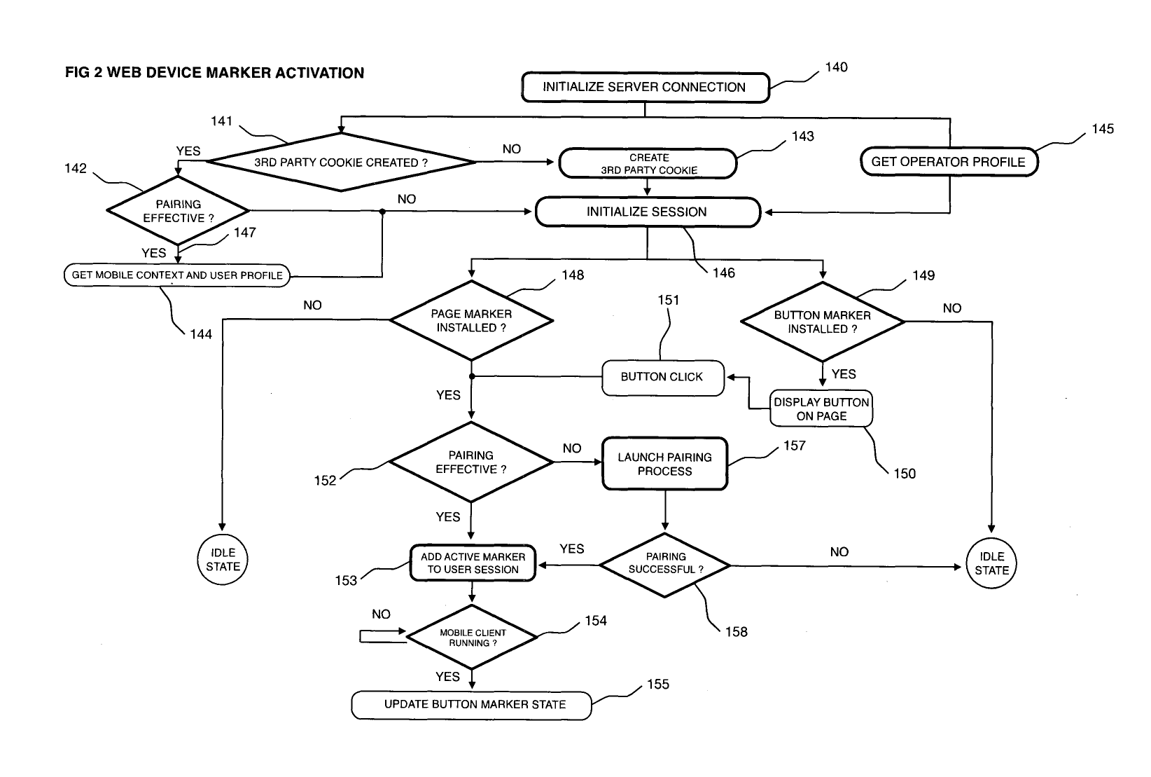

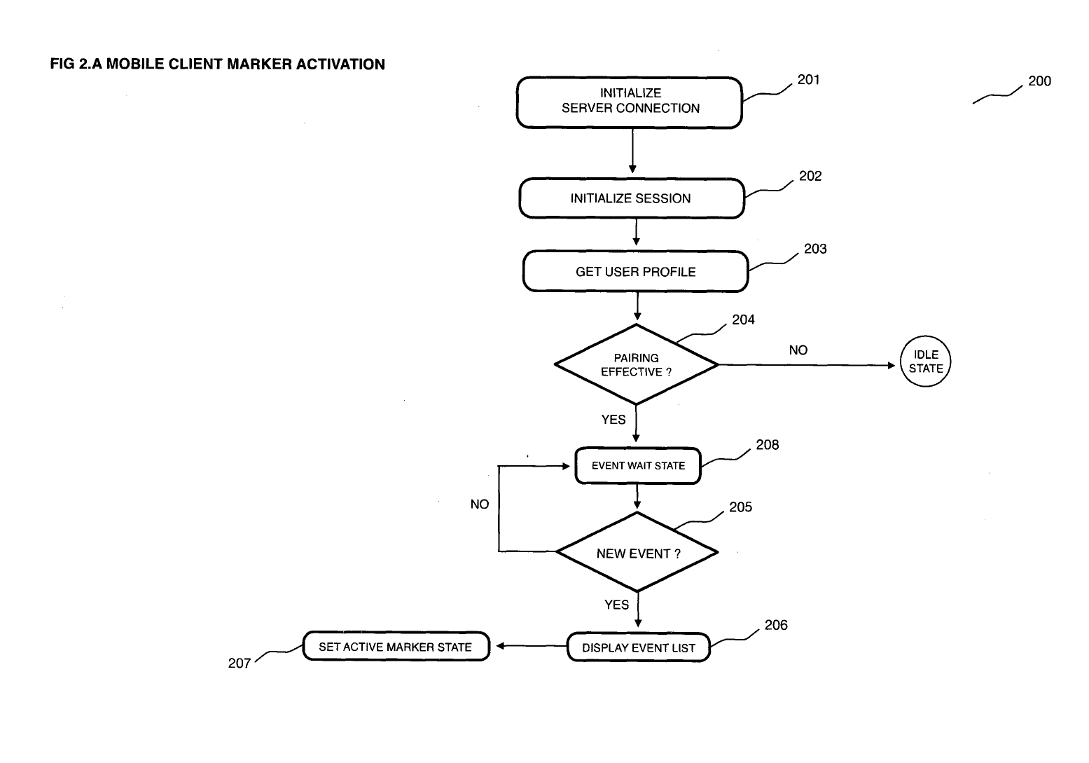

FIG. 2 shows the process by which the user activates said marker on the operator's web page: As soon as the web page is loaded by the browser, the server connection is initialized (step 140) and the system checks (test 141) if a third-party cookie exists for said browser. The purpose of this cookie is to identify the mobile devices (step 144) that have been paired (step 142) with the browser. If no cookie is identified, a third party cookie is created in step 143. At the same time, the operator profile containing personalization data such as the logo and color for the button marker is being obtained (step 145).

The session is then initialized (146) and a web socket real-time connection is established between the browser and the server via the Javascript Library code.

If the browser has already been paired (line 147) then the mobile client's local data such as the user's profile is analyzed in order to allow the personalization of the web page. Furthermore, if the mobile application is running then sensor data such as the GPS coordinates, Wifi, bluetooth beacon identification, fingerprint scan or the like can also be made available through the socket connection, upon user prior acceptance, in order to deliver even more personalized content.

The HTML code is then parsed to check the type of marker installed in tests 148 and 149.

Test 148 verifies if the page marker is installed. If not the session is terminated (IDLE State).

Otherwise, if a button marker (test 149) is present on the web page (block 150) and the user has clicked (block 151) on the button then if pairing is already effective (test 152), the marker is added (block 153) to the user's session. If the mobile application is running checked is successful (test 154) the state of the button marker state is updated on the web page (block 155) and the benefit is automatically displayed on the user's mobile device. Otherwise, if pairing (test 152) was not effective then the pairing process is started (step 157) and it is return to step 153. Otherwise, as if the test 149 is negative the session is terminated.

FIG. 2A shows an organigram illustrating the process 200 by which a user activates a marker. First, the server connection and the user session are initialized (steps 201 and 202). Then the user profile is obtained (step 203). The profile information allows the operator to personalize the web pages by knowing the age, gender, number of visits, number and types of benefits already obtained, etc. If the pairing is effective (test 204) and the user has activated a marker (step 205) then the benefit is displayed (206) on the mobile application and the state of the marker is updated to completed (207), otherwise the system waits (208) for a marker to be activated.

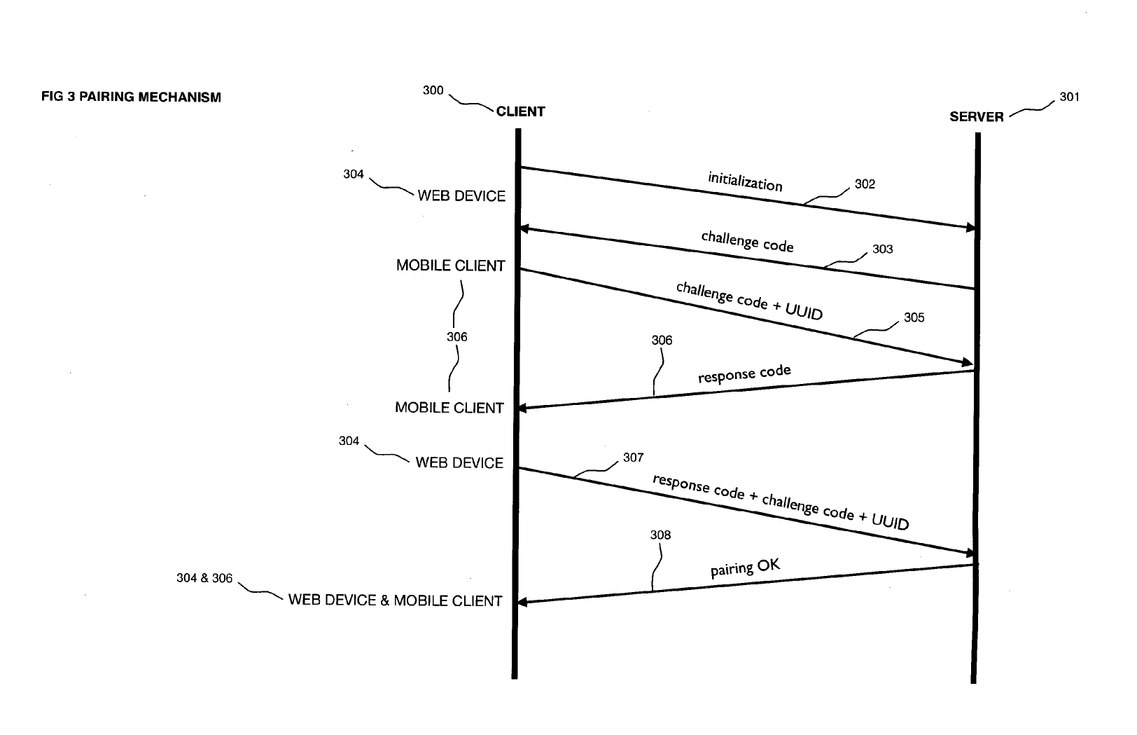

FIG. 3 shows the pairing mechanism adapted from challenge/response synchronization described hereafter.

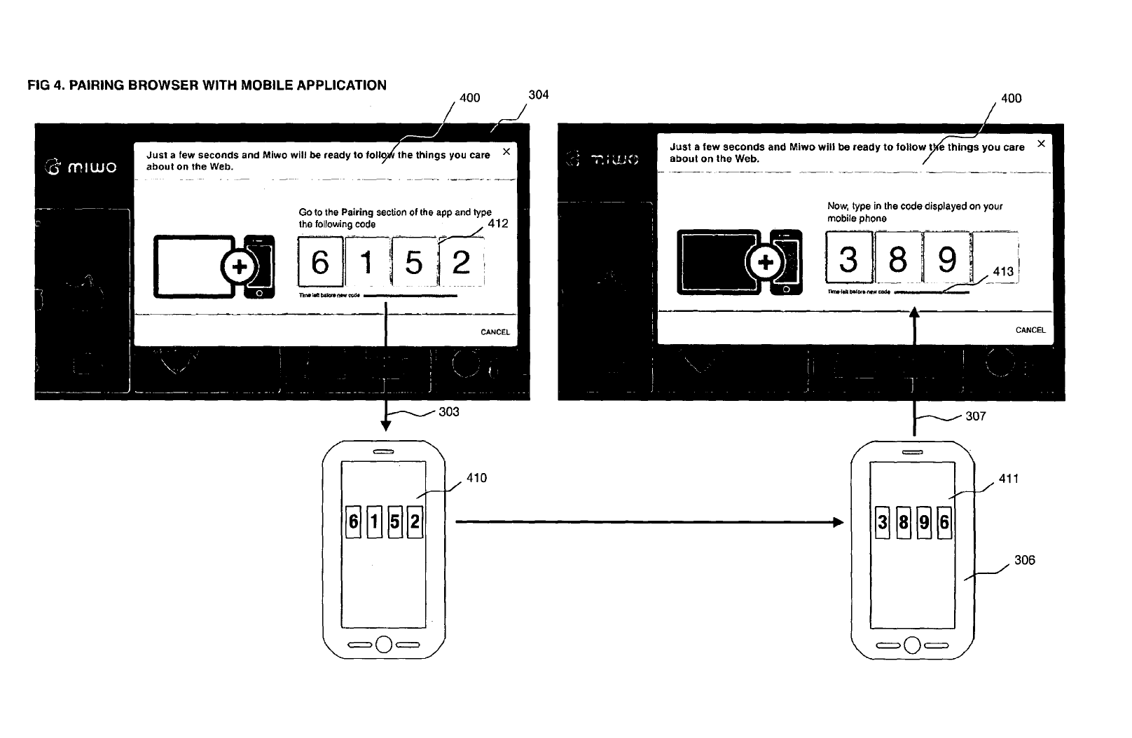

The pairing starts when the user (client 300) decides to obtain a benefit as also illustrated in reference to FIG. 4 from a server 301. A first server request (302) is initiated in order to generate a 4-digit challenge code. A pop-up window is then opened in the browser (web device 304) asking the user to type (step 303 in reference to FIG. 3), using the keyboard of the mobile application, a challenge code (410 in reference to FIG. 4) is displayed in said pop-up window.

Once the code (here 6152) is entered inside the mobile application, a second server request (305) checks if is the same as the challenge code and stores an associated UUID for the mobile client device.

A response 4 digit-code (here 3896) is generated (306) on the mobile application and an associated 4-character digit field is displayed in said pop-up window 400. The user enters (307) the response code in said digit field and a third server request stores the response code, challenge code and UUID to complete the paring mechanism (step 308). A timer 413 is also displayed to indicate the time left to enter the codes for each step of the process. If the time times out then a new code is automatically generated for the user.

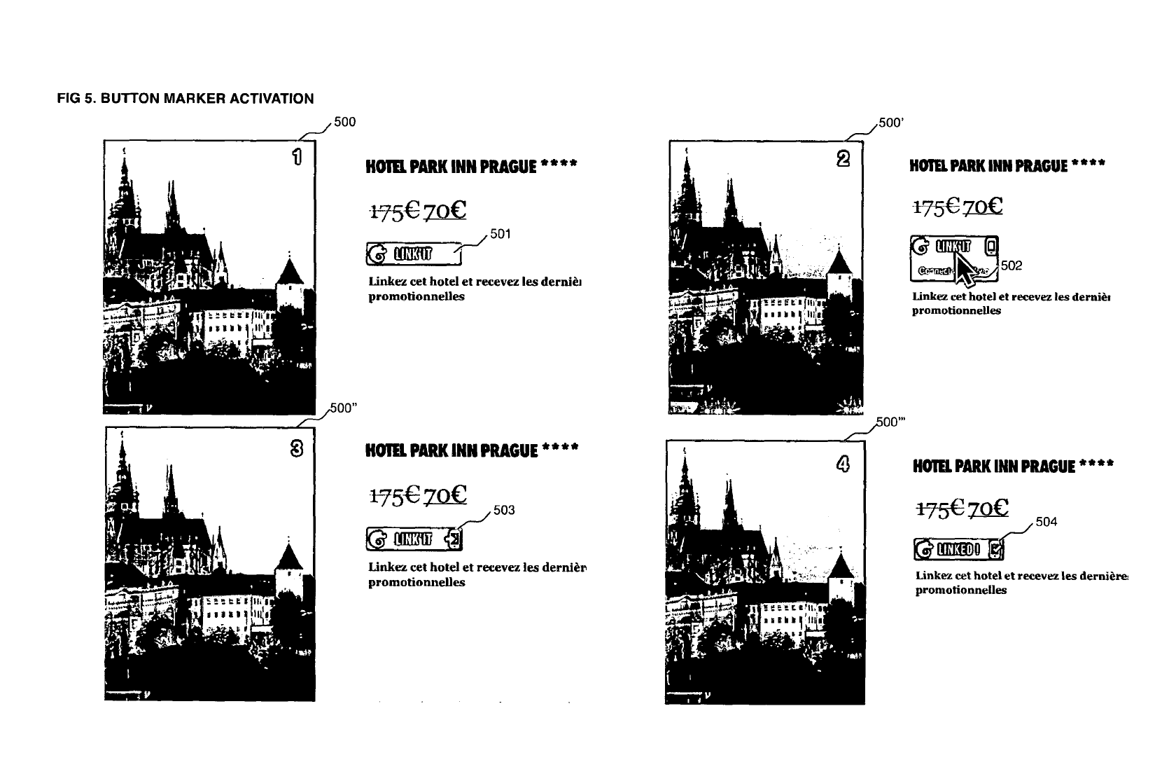

FIG. 5 shows schematically an embodiment of a scenario in which a user is activating a button marker 501 on a web site according to the embodiment of the invention more particularly described here on a web site 500 in form step 500 to 500′″.

Here it is to use the system to obtain a special price in an hotel in Prague.

In three steps, the user clicks (502) on button marker 501.

The button then shows an animation 503 which informs the user of the transfer of the benefit to the mobile application and finally the button 504 changes color to signify that the operation has been completed.

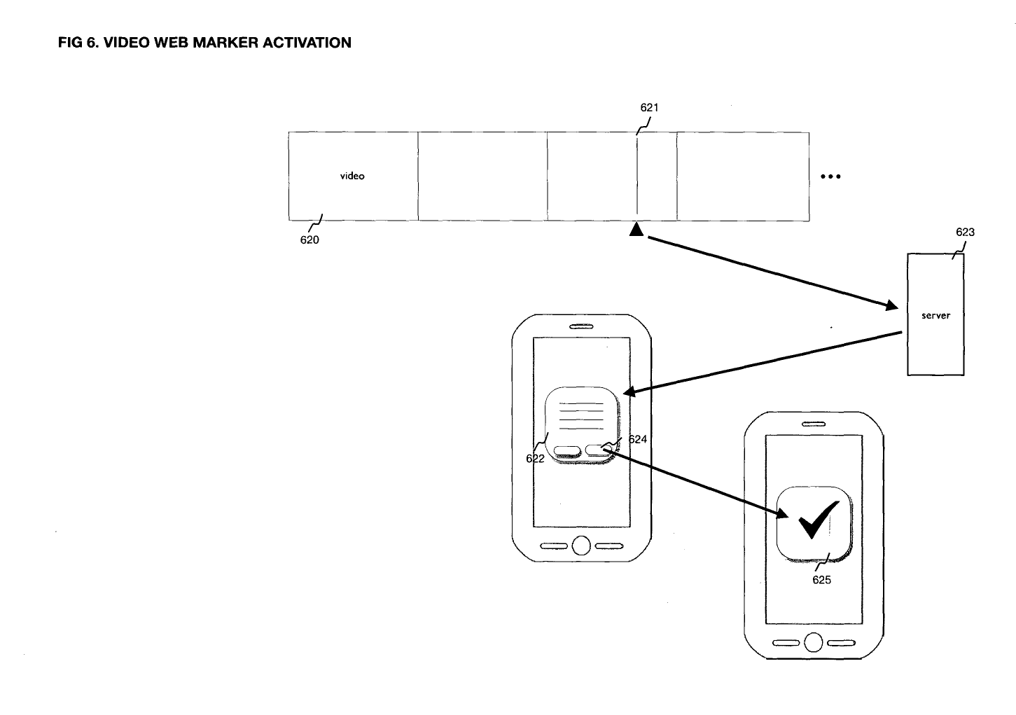

FIG. 6 shows an overview of a video web marker's activation. A video sequence 620 is played by the user. A timing function within the HTML marker code 621 triggers a server request 623 to notify the mobile application with a message 622 asking to accept or deny the reception of a benefit. If the user clicks on the “accept” button 624 then the benefit is transferred and stored in the mobile application 625.

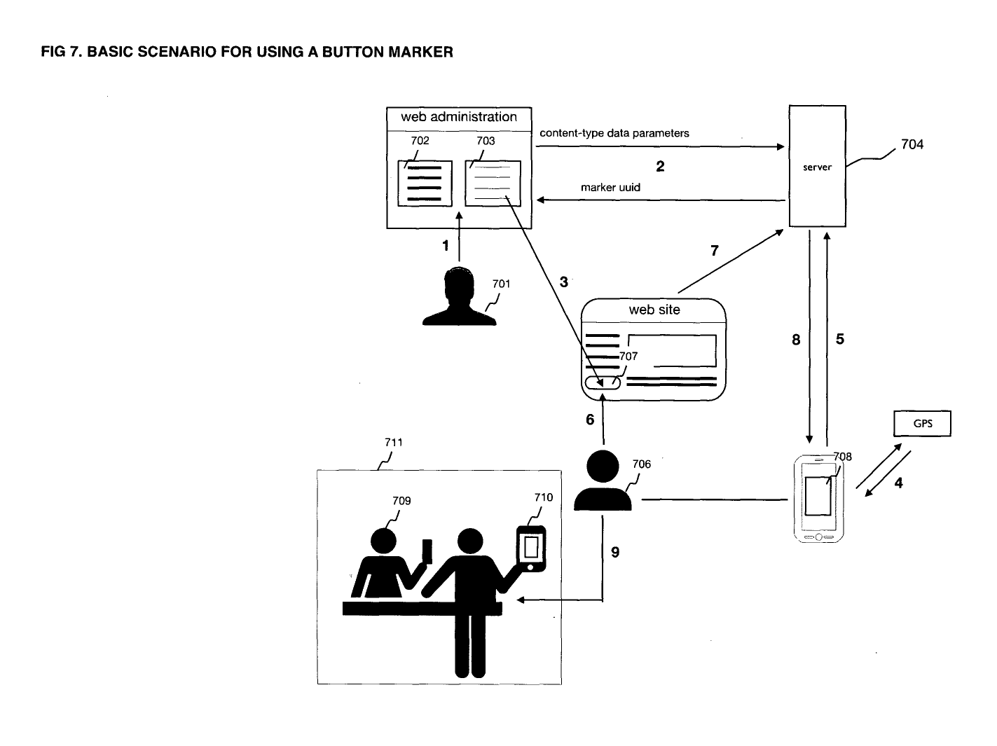

FIG. 7 shows a basic scenario of a web site owner creating a simple button marker on his web page and a user clicking on said button to activate the marker and receive the associated benefit inside his mobile application to be redeemed at the closest user location.

An operator such as a tea shop, also having physical retail locations 711, wants to drive traffic to his stores to discover a new tea flavor. The benefit is a 20% discount only redeemable at a store. Step 1, The web administrator 701 uses a web administration tool to define the benefits parameters 702 such as the title, description and amount to be discounted. Step 2, said parameters are then transmitted to a server 704 which sends back a unique identifier UUID and automatically generates the associated marker HTML code 703 to be inserted on said web site. Step 3, the web administrator inserts the code in the appropriate web page to generate the button marker. Step 4, the user 706 launches said mobile application as requested by the web site before clicking on the button marker 707. Step 5, launching the mobile application automatically transmits the GPS coordinates of the user to the server 704. Step 6, the user clicks on said button 707 to activate the marker and transfer the benefit 708 to the user's mobile phone as of step 8. Because the user's last GPS coordinates have been saved on the server, they can be used to customize said benefit to provide the discounted offer at the user's nearest tea store location. Once the discounted offer is stored in the user's mobile application, the user can then redeem the offer at the closest tea store. Step 9, activating the mobile application at the tea store allows for redeeming the offer through showing the sales person 709 the stored benefit 710 displayed on the mobile application or by using an NFC reader, Bluetooth beacon, bar code reader or the like.

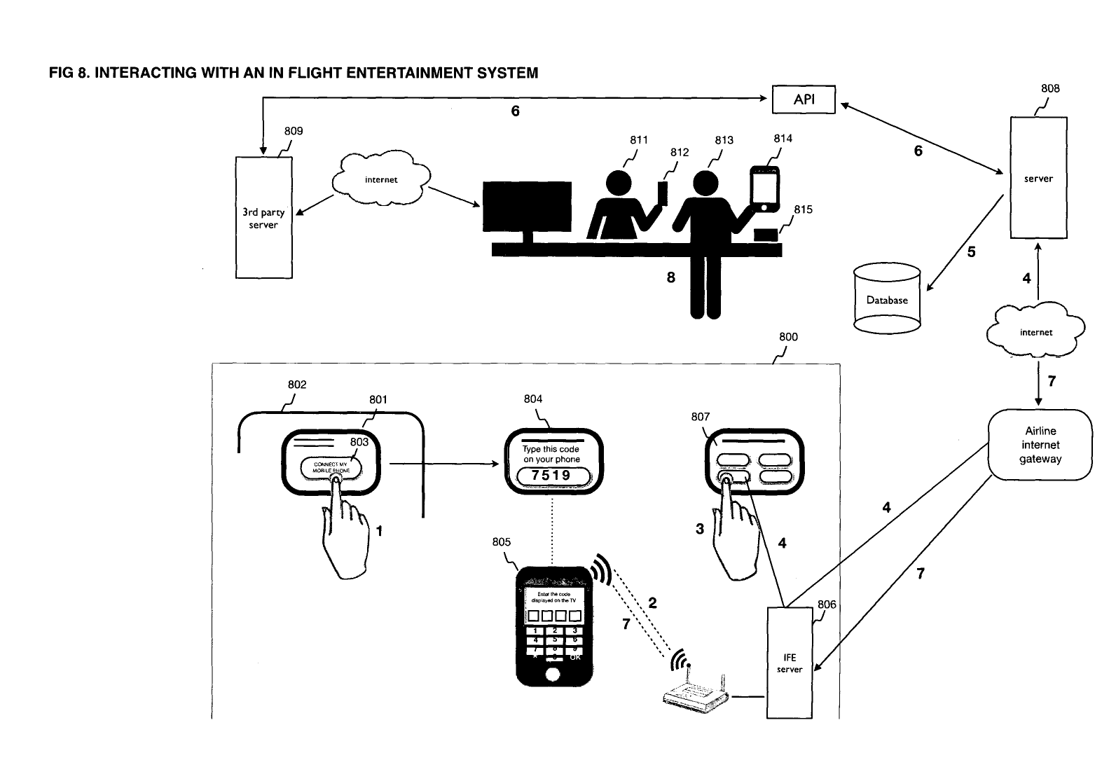

FIG. 8 shows the process by which an airline passenger can receive a benefit from interacting with an In Flight Entertainment (IFE) system aboard an airplane and redeeming said benefit at a physical location upon arrival.

An IFE video display 802 is generally located in the opposite passenger seat 801 inside an airplane. Step 1, the passenger accesses the “Arrival Services” menu section of the IFE then clicks on the “CONNECT MY MOBILE PHONE” button 803. The passenger is prompted on the video screen 804 to type-in a 4-digit pairing code on his mobile phone 805. Step 2, the pairing is accomplished with the process described in reference to FIG. 3 by using the on-board 800 wireless internet to connect the passenger's mobile phone 805 to the IFE's interactive services. Before completing the pairing process, a message is sent as an alert box on the passenger's mobile phone to verify his identity against the one associated with his seat number. Step 3, the passenger's mobile phone is now paired and he selects one service from the menu 807.

Step 4, once the service selection is completed, for example, booking 2 theater tickets for tonight's show, a request, is sent to the server 808, in order to transfer the reservation to the user's mobile application by writing the associated parameters to the user's UUID database entry, step 5, according to the invention. Step 6, the reservation is transmitted via an API to the booking service server 809 and confirmation is sent back to the server 808. Step 7, the server 808 sends back an alert or notification message on the passenger's mobile phone to confirm that the reservation confirmation has been saved to the mobile application. In case the notification does not reach the passenger due to a lack of onboard internet connection, said notification may be sent upon the arrival of the passenger at the airport. Step 8, upon arrival of the passenger 813 at the show, he can show his ticket reservation stored in his mobile application 814 to a hostess 811 or authenticate using an NFC reader 815 in exchange, for example, for a free drink coupon for two 812.

None of email or text message methods of the prior art can provide a unique storage to access and manage multiple offers and furthermore, using a mobile application allows for easier transactions with points of sale using, for example, near field communication or biometric authentication.

As indicated above, one or more operations according to at least some embodiments may be performed by a mobile application and/or web browser. Such application and/or browser may be executed on a mobile phone or other user device having one or more processors and one or more types of memory, the processor(s) and memory(ies) storing executable instructions and/or hard-coded logic that configure(s) the mobile phone or other user device to perform operations such as are described herein. The mobile phone or other user device may further include one or more transceivers configured to facilitate two-way wireless and/or wired communication between the mobile phone or other user device and one or more servers or other computers via one or more wired and/or wireless networks.

As indicated above, one or more operations according to at least some embodiments may be performed by one or more servers. Such server(s) may comprise one or more computers having one or more processors and one or more types of memory, the processor(s) and memory(ies) storing executable instructions and/or hard-coded logic that configures the computer(s) to perform operations such as are described herein. The computers may further include one or more transceivers configured to facilitate two-way wireless and/or wired communication between the computers and mobile phones or other user devices via one or more wired and/or wireless networks.

Embodiments include, without limitation, methods such as are described above. In some embodiments, a method includes one or more of the above-described steps performed by a mobile phone or other type of mobile device. In some embodiments, a method includes one or more of the above-described steps performed by one or more servers and/or other network elements. In still other embodiments, a method includes one or more of the above-described steps performed by a mobile phone or other type of mobile device, as well as one or more of the above-described steps performed by one or more servers and/or other network elements.

Embodiments additionally include mobile phones or other mobile devices configured to perform steps of methods described herein, servers and/or other network elements configured to perform steps of methods such as are described herein, and systems of mobile phones or other mobile devices and servers and/or other network elements configured to perform steps of methods such as are described herein.

Embodiments further include one or more non-transitory machine-readable storage media storing instructions and/or hard-coded logic executable by one or more processors of one or more devices to perform steps of methods such as are described herein.

As goes without saying and as also results from the foregoing, the present invention is not limited to the embodiments more particularly described. On the contrary, it covers all the variants thereof and notably alternative web programming languages.

1. A method for dynamically creating a function or information data to be used by a user, said function or data information being called a benefit, said method using a web-based marker displayed inside an internet browser or a web application to transfer said benefit to a mobile phone application, characterized in that it comprises the steps of
(i) creating a web-based marker using a dedicated user-interface or an API (Application Program Interface),
(ii) creating an HTML content for said benefit using said user-interface,
(iii) associating said HTML content to said web-based marker,
(iv) installing a dedicated Javascript library on a website to manage the display and functionality of said web-marker,
(v) creating the HTML tags necessary to display said marker,
(vi) activating said marker,
(vii) checking whether the user's mobile application was previously paired with the internet browser displaying said web page by checking an HTTP cookie,
(viii) otherwise pairing the mobile application using a challenge/response synchronization mechanism known by the skilled practitioner,
(ix) getting or polling local data provided by the mobile application,
(x) adding said marker to the user's web context, by sending said functional parameters to a server upon activation of said marker,
(xi) sending a content list corresponding to said benefit based on user profile, mobile and web context,
(xii) displaying said content list inside the mobile application once and as soon as the application is connected to the internet, and
(xiii) storing said benefit in the mobile's phone application local memory.

2. A method according to claim 1, characterized in that pairing the mobile application is provided by placing said cookie in the user's web browser indicating that pairing is effective.

3. A method according to claim 1 characterized in that said marker is associated with a web content.

4. A method according to claim 1 characterized in that it comprises the steps of allowing incremental points awarded when the user clicks on a button on a web page.

5. A method according to claim 1 characterized in that it comprises the steps of allowing incremental points awarded every time the user plays video or sound content on a web page.

6. A method according to claim 1 characterized in that it comprises the steps of allowing incremental points awarded the user loads a web page or a section of a web page.

7. A method according to claim 1 characterized in that the use of the benefit is customized according to local data provided by the mobile phone.

8. A method according to claim 7, characterized in that said local data is GPS coordinates.

9. A method according to claim 8, characterized in that it comprises the steps of allowing benefit customization based on the user's precise location whereby the benefit parameters stored on the mobile phone contain the nearest point from the user's location to redeem such benefit.

10. A method according to claim 7, characterized in that said local data is provided by a local wireless device such as a Wifi router, bluetooth beacon, NFC tag or the like.

11. A method according to claim 7, characterized in that said data contains accelerometer, sound and/or image and/or biometric sensors.

12. A method according to claim 7, characterized in that said local data contains crypted payment information such as credit card numbers, stored securely inside the phone's application.

13. A method according to claim 1, characterized in that a benefit transferred from the web page is redeemed in a physical location.

14. A system implementing a method according to claim 1, characterized in that it includes at least a mobile phone, a web device and a server instance.
